(19) United States
(12) Patent Application Publication
(10) Pub. No.: US 2015/0113057 A1
(43) Pub. Date: Apr. 23, 2015

(54) SYSTEM AND METHOD FOR ANONYMOUS REAL TIME PARTICIPANT ENGAGEMENT

(71) Applicant: Louis M. Carricarte, Doylestown, PA (US)

(72) Inventor: Louis M. Carricarte, Doylestown, PA (US)

(21) Appl. No.: 14/057,454

(22) Filed: Oct. 18, 2013

(51) Int. Cl. H04L 29/08

(52) U.S. Cl. CPC H04L 67/22
USPC 709/204

(57) ABSTRACT

Disclosed herein is a system and method of real time data input, aggregation, correlation, interpretation, and dissemination that allows for anonymous participant input while interpreting and disseminating the data in real time to a client based on encrypted characteristics of the participants that makes the data relevant immediately upon its dissemination. The results are disseminated through a communication network with the client.

### STATEMENT REGARDING FEDERALLY SPONSORED RESEARCH OR DEVELOPMENT

The present invention was not developed with the use of any Federal Funds, but was developed independently by the inventor.

### CROSS-REFERENCE TO RELATED PATENTS AND APPLICATIONS

This application does not claim the benefit of any prior applications.

### FIELD OF THE INVENTION

The present invention relates generally to the field of mobile applications and to a system and method of social participant engagement where the data from multiple participants is aggregated and analyzed in real time and transmitted for viewing on a secure server.

### BACKGROUND

Social user interaction has become a critical tool for entities in understanding the social landscape in which they operate. People are the sustainable resource in this age of disruptive innovation, fast-paced change and fluidly shifting markets. Electronic communication has quickened to the point of being nearly instantaneous. User friendly and highly available access to information portals represents a competitive advantage. Instant online communication creates valuable opportunity. It enables companies to harness knowledge about their customers. It enables the widespread dissemination of news. It spurs discussion and debate enabled by social media sites such as Twitter and others. Instant communication has even ventured into the political realm where it allows political parties to address and respond directly to the public and thereby to understand their constituents. With the multiple ways in which people are connected in today's business, political, and social climate, not knowing something within a relatively short period of time, such as an hour or less, puts one out of touch and at a disadvantage.

In certain instances, participants wish to remain anonymous when giving their input to a particular request, issue, event or situation. In such instances, anonymity is necessary in order to first, obtain participant engagement in the process; and second, in order to obtain accurate and realistic feedback from the individuals who choose to engage. An additional factor is the requirement for secure transmission of information supplied by the participants that creates a secure environment for digital content within such system.

Until now, certain systems for processing events and analyzing data in the social domain have been disclosed. For example, U.S. Pat. No. 8,504,397 to Vempati discloses a system that processes real time business event monitoring and tracking by a server, which receives data, typically through RFID or 802.11 (including Wi-Fi™) transmissions, from a number of data collection devices which, in turn, acquire input from individual users. The server analyzes the data in conjunction with previously input historical data and additional business or logistical rules and filters and identifies specific business events based on the analysis. Calculations of the collected data and resulting analyses are conducted in real time and sent back to the client on the same data collection device or a different display device. Vempati et al. does not provide for anonymity of the participants.

U.S. Pat. No. 7,937,416 to Hossfeld et al. discloses a data management system that aggregates data for a plurality of schools and universities. This data is systematized into categories. The patent does not disclose the anonymous submission of input by participants. U.S. Pat. No. 8,146,103 to Schmidt et al. teaches data aggregation as a means of interpreting business events. Schmidt et al. compare existing data to identify business events and provide a means for distributing this information back to a client. However, Schmidt et al. utilize preexisting business data and do not disclose the use of participant-generated real time data input.

U.S. Pat. No. 8,171,561 to Moskowitz et al. discloses a system containing encryption of data to enable anonymity of transaction flowing through a remote server. The invention is tailored towards secure transactions for use in the music industry. Moskowitz et al. recognize the possibility of users being able to access real time information, but here again the disclosure does not recognize the importance of real time aggregation and distribution of data to a client. U.S. Pat. No. 6,081,793 to Challener et al. discloses a system for the aggregation of data for voting events. The system maintains anonymity of participants. As voters send data, a server authenticates whether a voter is registered and is of proper age to vote. No disclosure is made as to the need for real time aggregation or dissemination of the data or results.

Other methods and/or systems include U.S. Pat. No. 7,318,049 to Iannacci for an interactive online, incentive-controlled system that finds useful patterns in data, with or without participant input; U.S. Pat. No. 7,172,118 to Urken discloses a system that aggregates and analyzes data for use in optimal decision-making scenarios in military applications; U.S. Patent Application No. 2005/0138642 to Breh et al. discloses a system and method for monitoring resources that send, filter, and aggregate low-level events in order to detect high-level events; and U.S. Pat. No. 6,754,704 to Prorock discloses a method of monitoring events in a data processing system with real time data distribution.

While a multitude of systems and methods exist in the public domain relating to data collection, aggregation or interpretation, as well as systems and methods for anonymous user participation, a system for collecting, interpreting and disseminating data in real time based on user input from participants with selectively encrypted characteristics has not previously been disclosed. The anonymous participant engagement measurement system of the present invention comprises a combination of components that provide value and advantage over the prior art.

### SUMMARY OF THE INVENTION

The current invention is a method for measuring anonymous participant engagement to an event occurring in real time, that involves (a) providing to the participant a mobile application executable on a mobile device, (b) assigning a unique identifier to the participant using encryption software in the mobile application, (c) collecting targeted information about each participant, (d) allowing said participant to input a command via the mobile application that indicates the participant's level of engagement to the event, (f) receiving on a data processing apparatus the command data from multiple participants, (g) aggregating the command data received from multiple participants, (h) interpreting the aggregated data received from the participants in relation to the targeted characteristics of the participants, (i) generating a report of the interpreted data, and (j) transmitting the report to a client upon generation of the report, wherein the identity of each participant remains anonymous. A system to carry out the method of the invention is also provided.

### DETAILED DESCRIPTION OF THE INVENTION

Disclosed herein is a method for measuring anonymous participant engagement to an event occurring in real time. Engagement includes approval or disapproval or another emotional response by the participant. The method includes (a) providing to the participant a mobile application executable on a mobile device, (b) assigning a unique identifier to the participant using encryption software in the mobile application, (c) collecting targeted information about each participant, (d) allowing said participant to input a command via the mobile application that indicates the participant's level of engagement to the event, (e) receiving on a server the data transmitted by multiple participants and aggregating the data received, (f) interpreting the aggregated data received from the participants in relation to the targeted characteristics of the participants, (g) generating a report of the interpreted data, and (h) providing the report to the client, wherein the identity of each participant remains anonymous to the client.

It is anticipated that the present invention is useful to any and all kinds of entities of any kind, public or private, large or small, including, but not limited to organizational, business entity, government, educational institution, military, sports club or team, entertainment, community, religious institution or any other. Within the scope of the invention, such an entity will be referred to hereinafter interchangeably as a “client”. The client herein is a party that is interested in obtaining certain information from a particular group of individuals, the participants. As referred to herein, by “participant” is meant any human individual who is a member of a group or part of any such client entity, for example, such as an employee in a business, a voter registered with a political party, a faculty member or a student of a university, a team member of a sports team, and the like. According to the system and method of the invention, as referred to herein, the term “event” is meant to include any and all types of occurrences, activities, situations, scenarios, conditions or other circumstances which an individual may observe, have knowledge of or with which the individual may be somehow involved, in other words, as referred to herein, an event in which a participant may be “engaged”.

According to the system and method of the invention, one of the objects of the invention is to obtain participant input while the participant experiences a particular event and provides real time input via a mobile application in response to the event. The mobile application wirelessly transmits the input to a server. The “input” is an artificially generated propagated wirelessly transmitted signal that is generated to encode information for transmission to a suitable receiver data processing apparatus.

The system is not limited by the number of inputs the system can receive. Input data is collected on data processing apparatus from multiple participant members of a particular group or client entity who engage in the same event. The data is concurrently aggregated by the remote server. The aggregated data is then analyzed for certain criteria and a report with interpreted results is generated. The system of the invention is not limited by any number of calculations or analyses performed by the software. The report is then provided to the client in real time without the identification of the participants.

By the term “engagement” herein is meant that a participant provides feedback or input to an event via the mobile application. The term “real time” as used herein means either simultaneously, immediately, or promptly. In the case of participant engagement, the input is submitted via the mobile application preferably simultaneously as a given event is occurring, or within a relatively short period of time, preferably within minutes up to one hour of the event. In the case of providing the report to the client, it is anticipated that the report is transmitted after a brief lag of time, as soon as it is processed by the software and generated by the server. Though the system and method are operable after some period of time even if not immediate, the usefulness of the system and method disclosed is diminished as time passes simply because instant or prompt information may have greater importance with respect to an actionable solution or plan by the client. Over time, the collection of real time data allows normalization of results, adds validity to the process, and can be used to compare with historic or key performance indicators. This will also allow users to establish trends over time.

It is a critical aspect of the invention that prior to participant engagement, the participants are identified and certain participant data is recorded relating to any given set of desired characteristics of interest set forth by the client. Each participant is assigned a unique identifier. The identity of the participant is then encrypted and remains unknown to the client. The system includes an encryption module for encrypting or otherwise securitizing data obtained from each participant. Therefore, accompanying the input with each and every transmission is an anonymous identifier uniquely associated with the individual participant who created the input. This identifier can be any series of numbers, letters, symbols, and characters, whose level of encryption can vary with the size of the client. The data processing apparatus associates the unique identifier with different categories or segments of interest to the client. Segments of interest recorded for each participant may include, but not be limited to, participant's location, department in which the participant is employed, participant's position level within the company, participant's political party or affiliation. Other characteristics of interest in embodiments of the invention can include age, sex, race, years of education attained, salary, geographic territory, market segment, price, strategic business unit, brand, or political party and other factors that would be correlated in order to inform the client entity regarding certain segments of interest. The date processing apparatus corresponds the transmitted input and unique identifier of each participant with the particular characteristics of the individual participant. The data is recorded by the data processing apparatus, encrypted by encryption software, and remains unknown by the business or entity in which the participant is involved, thereby ensuring that participant anonymity is protected.

Once participant data is aggregated, it is an aspect of the invention that the data is correlated and interpreted with respect the given participant characteristics to determine key performance or economic indicators to create information useful to the client. Therefore, it is an important aspect of the invention that participants remain anonymous in order to effectuate greatest participant engagement level and accuracy of participant feedback to a given event.

According to the invention, participant input is recorded by a mobile software application previously downloaded on the mobile device of the participant. The mobile device according to the invention is equipped with wireless connectivity. In the preferred embodiment, the mobile software application is as simple as a single depression of an icon or button by the participant that are commonly provided by mobile apps. In another preferred embodiment, the mobile application comprises two icons or buttons or a small series of icons or buttons. The mobile application transmits the encrypted identifier of the participant, (2) a timestamp of the input, and (3) a global positioning system (GPS) signal indicating the location of the input and transmission. These simple commands generate data in the form of the participant's emotionally driven input. This input stems from a thought, emotion, or feeling, and manifests as a complaint, suggestion, or other form of information to the client. The icon itself can be a “thumbs up” or a “thumbs down” depiction, a check mark, a number, a color, or any other suitable graphic or design element whatsoever that indicates a thought, emotion or feeling. The level of engagement can be measured by the number of depressions of the mobile application, i.e., the amount of input of the participant into the system, wherein the greater the number of depressions, the higher the level of participant engagement indicating greater emotion or feeling that the participant wishes to communicate.

Embodiments of the invention and all of the functional operations described in this specification can be implemented in digital electronic circuitry, or in computer software, firmware, or hardware, including the structures described in this specification and their structural equivalents. Embodiments of the invention can be implemented as one or more modules of computer program instructions encoded on a computer readable medium, e.g., a machine readable storage device, a machine readable storage medium, a memory device, or a machine readable propagated signal, for execution by or to control the operation of data processing apparatus. The term “data processing apparatus” encompasses all apparatus, devices and machines for processing data, including, by way of example, a programmable processor, a computer, or multiple processors or computers. According to the invention, the data processing apparatus includes code that creates an execution environment for the computer program in question that enables aggregation, correlation and analysis of the input data.

The computer programs used in conjunction with the method and system of the invention, also commonly known as program, software, application, script, or code, can be written in any form of programming language, including compiled or interpreted languages, and can be deployed in any form, including as stand-alone programs or as a modules, components, subroutines, or other units suitable for use in a computer environment. The computer programs can be deployed to be executed on one computer, on multiple computers or servers that are located at one or distributed across multiple sites and interconnected by a communication network.

Furthermore, the processes described in this specification can be performed by one or more programmable processors executing one or more computer programs to perform functions by operating on the input data and generating the output data or report. Processors suitable for execution of the computer programs useful herein include microprocessors and any one or more processors of any kind of digital computer. The computer will also include or be operatively coupled to a communication interface to receive the input data or to which the input data is transferred, or both; and one or more mass storage devices for storing data, such as magnetic optical disks or optical disks.

According to the invention, the client receives the report via software developed for the client according to the steps of the invention to enable the client to access the information in real time. Any means for receiving information, such as computers, dashboards, or any other display device are within the scope of the invention. To provide interaction with the user client, embodiments of the invention can be implemented on a computer wherein the display device, such as a cathode ray tube (CRT) or liquid crystal display (LCD) monitor, for displaying information to the user. A keyboard and pointing device such as a mouse or trackball by which the user can access the report and provide input to the computer to manipulate the data further according to the user's needs is also contemplated within the scope of the invention. The components of the system can be interconnected by any form or medium of digital data communication network, including for example, local area network (LAN) or a wide area network (WAN) such as the internet. A secured network is preferred. The advantages of the invention are demonstrated by the examples below.

### EXAMPLES

The following examples are set forth to illustrate the system and method of the invention and are intended to be purely exemplary of the use of the invention and should not be viewed as limiting in its scope. Tracking real-time engagement provides an imminent perspective and a long term view to a client based on patterns of behavior and the correlated impact on key performance indicators of an organization. Value is realized as a map of real-time participant engagement emerges or trends normalize and create predictive analytics for nimble organizations to pivot towards an opportunity.

### Example 1

An interactive application for a mobile device enables organizations to record the brand performance at a certain period in time. Capturing internal metrics provides a measurement of engagement based on the vision, values and the execution of brand strategy. The data fed from the market delivers metrics based on the delivery of the brand according to each customer's expectations. For example, the system of the invention can be used by a hotel chain with seven brands that span the breadth of the market. Each brand is designed to attract and retain a targeted segment. According to the invention, loyalty members would be provided access to the mobile application supplied by the hotel as part of the loyalty program to be used during their stay for recording engagement as they participate with the family of brands. The hotel would define the characteristics for each loyal customer to include demographic, financial and psychographics segments. A loyal group of willing participants will express themselves based on the performance of the brand versus their expectations. The engagement data will be aggregated and correlated against the company's key performance indicators to identify areas of value addition to its brand. Brand performance, guest tendencies by targeted segments and the ability to quantify company engagement efforts are examples of analytics that can be delivered by the system of the invention to the hotel chain to effectual real time engagement and value.

### Example 2

Another embodiment illustrating applicability of the invention occurs with any manufacturer of large lifestyle products such as boats, motorcycles, cars, trucks and the like which offer a selection of products and options to earn share in the market. Each of the products are targeted for a segment, or multiple segments, of a market based on the behavioral characteristics of an individual participant. These types of manufacturers have a number of tools and reports used to track the historical trends of its target market. The missing dimension until now was the lack of data available indicating real-time feedback regarding use of the product. It is often a practice in the industry that after a major purchases, the manufacturing organization will conduct a survey where a willing participant completes a form after some significant passage of time. With real-time engagement according to the invention, the customer can provide input in real-time as the customer acquires ownership and during the lifecycle of the product. Information for each market segment will reflect true brand performance based on the expectations of the segment. Companies can use the trends and analysis to sharpen the position of the products, adjust communication to the desired attributes or develop new products to fill the emerging niche of the segment. Businesses can use this data to adjust product and service offerings to align with the demands of the segment.

### Example 3

In another embodiment, the participants are guest of a particular establishment or venue. Guest engagement tracked in real time can be used to create heat maps as a guest moves throughout a venue. These events can include theme park visits, conferences, tradeshows, sporting events and vacations. As engagement escalates in regions of a map, the host can investigate, communicate and mitigate the situation and take advantage to strengthen a particular brand. For example, if a theme park were measuring engagement in real-time, areas of opportunity can be identified as the map shows high levels of interaction from the guests indicating their feeling that the brand is delivering less than the participants' expectation. The engagement may identify frustrating bottlenecks at various times throughout the theme park or a possible correlation of a temperature heat index and areas that require more fluids to be dispensed or water misters to be deployed to help cool the guests of the theme park.

### Example 4

It is contemplated herein that the feedback input by the participants via the engagement system herein will typically be emotionally motivated or driven. For example, in one embodiment, employees of a particular factory will be able to provide instantaneous feedback in the event they do not approve the way a particular method of the production line operates, for example, if the speed of the assembly line is increased by the factory foreman, line workers can indicate their disapproval by sending input via their mobile application. The aggregated data will be instantly aggregated, encrypted and sent to management so that the foreman can lower the speed of the assembly line to a level acceptable by the assembly line workers. In another embodiment, students at a university on an exam may show their real time disapproval with respect to how a particular exam is being administered. The aggregated results can then be interpreted for relevance by the university. If the university receives a certain amount of data indicating a high level of disapproval, then the university will be on notice that something out of the ordinary is happening while the exam is being administered. This will allow the university to review and address the situation promptly.

### Example 5

Market research organizations can use the system and method to gather relative information and behaviors about targeted groups and compare to historical performance and control groups.

The particular embodiments described herein are provided by way of example and are not meant in any way to limit the scope of the claimed invention. It is understood that the invention is not limited to the disclosed embodiments, but on the contrary, is intended to cover various modifications and equivalent arrangements included within the spirit and scope of the appended claims. Without further elaboration, the foregoing will so fully illustrate the invention, that others may by current or future knowledge, readily adapt the same for use under the various conditions of service.

What is claimed is:

1. A method for measuring anonymous participant engagement to an event occurring in real time, the method comprising,
(a) providing to the participant a mobile application executable on a mobile device,
(b) assigning a unique identifier to the participant using encryption software in the mobile application,
(c) collecting targeted information about each participant,
(d) allowing said participant to input a command via the mobile application that indicates the participant's level of engagement to the event,
(e) receiving on a data processing apparatus the command data from multiple participants,
(f) aggregating the command data received from multiple participants,
(g) interpreting the aggregated data received from the participants in relation to the targeted characteristics of the participants,
(h) generating a report of the interpreted data, and
(i) transmitting the report to a client upon generation of the report, wherein the identity of each participant remains anonymous.

2. The method of claim 1 wherein the mobile device is a smartphone, tablet or personal digital assistant (PDA.)

3. The method of claim 1 wherein the mobile application comprises an icon to be depressed directly by the participant in order to indicate the participant's level of engagement.

4. The method of claim 1 wherein the targeted characteristics of the participants are age, sex, race, years of education attained, salary, geographic territory, market segment, price, strategic business unit, brand, or political party.

5. The method of claim 1 wherein the interested party is a business entity, educational institution, body of government, military institution, sports club, community or religious institution.

6. The method of claim 1 wherein the mobile application command input by a participant transmits information comprising an encrypted identifier for such participant, a time stamp, and a GPS signal.

7. The method of claim 1 wherein the encrypted identifier is selected from numbers, letters, symbols, and characters.

8. The method of claim 1 wherein the input command indicates the participant's engagement with the event by pressing on one icon and the level of engagement is measured by the number of depressions.

9. The method of claim 1 wherein the input command indicates the participant's level of engagement with the event by choosing between two or more icons in the mobile application.

10. The method of claim 1 wherein the client receives the report on a mobile dashboard.

11. A system for anonymously measuring the level of engagement to a given event occurring in real time by at least one participant, the system comprising:
(a) an encryption software that encrypts a unique identifier associated with each participant,
(b) a data collection component that records the targeted characteristics of each participant,
(c) a mobile application for a mobile device having wireless connectivity to the Internet, wherein each participant inputs a command that indicates such participant's engagement to the given event, and
(d) a data processing apparatus that receives the transmitted command input by each participant,
wherein the data processing apparatus aggregates the command data generated by each participant, interprets the aggregated data based on a given set of criteria in relation to the targeted characteristics of the participants, generates a report, and transmits the report to an interested party in real time upon being generated, and wherein the identity of each participant remains anonymous.
